(19) United States
(12) Patent Application Publication
(10) Pub. No.: US 2025/0249731 A1
(43) Pub. Date: Aug. 7, 2025

(54) VEHICLE DOOR WITH CARRIER MODULE HAVING SUSTAINABLE CARRIER

(71) Applicant: MAGNA CLOSURES INC., Newmarket (CA)

(72) Inventors: Sally CHOU, Newmarket (CA); Milos PAVLOVIC, Newmarket (CA); Raymond Edward FORTIN, Newmarket (CA); Vesa PAVLOVIC, Newmarket (CA); Saikat BOSE, Newmarket (CA)

(21) Appl. No.: 19/044,854

(22) Filed: Feb. 4, 2025

Related U.S. Application Data
(60) Provisional application No. 63/737,790, filed on Dec. 22, 2024.
(60) Provisional application No. 63/669,302, filed on Jul. 10, 2024.
(60) Provisional application No. 63/550,237, filed on Feb. 6, 2024.

(51) Int. Cl. B60J 5/04

(52) U.S. Cl. CPC B60J 5/0413; B60J 5/0415; B60J 5/0418; B60J 5/0469

(57) ABSTRACT

A carrier of a carrier module for a motor vehicle door assembly and method of manufacture thereof is provided. The carrier module has a carrier body made at least in part of sustainable material. An attachment feature is secured to the carrier body at a mounting location to secure an accessory component to the carrier body. The attachment feature receives a fastener that facilitates securing the attachment feature and the accessory component to the carrier body.

### CROSS-REFERENCE TO RELATED APPLICATIONS

This application claims the benefit of U.S. Provisional Application Ser. No. 63/737,790, filed Dec. 22, 2024, and of U.S. Provisional Application Ser. No. 63/669,302, filed Jul. 10, 2024, and of U.S. Provisional Application Ser. No. 63/550,237, filed Feb. 6, 2024, which are each incorporated herein by reference in their entirety.

### FIELD

The present disclosure relates generally to vehicle door assemblies, and more particularly to sustainable carrier modules therefor.

### BACKGROUND

This section provides background information related to the present disclosure which is not necessarily prior art.

The automotive industry continuously seeks to utilize materials that are lightweight, readily recyclable and environmentally sustainable in components, where possible. However, in some cases, such as when a component may be exposed to high forces and/or exposed to moisture, the component may be made of a relatively heavy metal and/or plastic materials. While plastic materials may be recyclable, current inspection and sorting stations used to identify recyclable materials, such as via optical recycling sorting cameras, generally overlook plastic material components due to their being dark, and in most cases, black. Further yet, plastic materials generally are not environmentally friendly or biodegradable. One such component that is known to be made of metal or plastic is a carrier of a carrier module. Although metal or plastic carriers can be useful to provide desired structural and barrier functions (preventing debris and fluid from transferring from a wet side of the carrier module to a dry side of the carrier module and generally being able to resist degradation when exposed to moisture/fluid), they tend to be relatively heavy, thereby negatively affecting fuel efficiency via added weight, which is also receiving ever-increasing attention, such as through fuel economy regulation laws. Accordingly, the metal and plastic materials tend to by challenging to recycle in addition to being less than ideal from an environmental sustainability standpoint.

In addition to the aforementioned drawbacks presented by known carrier modules, further drawbacks can result during high impact. High impact forces on known metal and plastic carrier modules can cause the carrier module to be broken into multiple separate pieces, also referred to as fragments, which can prove problematic. For example, one or more of the fragments may result in unwanted projectiles and/or have a sharp edge, which could increase the likelihood of the fragment penetrating into an internal cabin of the vehicle and/or puncture an inflationary restrain device, often referred to as “air bag,” thereby potentially reducing the efficacy of the air bag.

Further yet, consideration must be given to the manufacture and assembly of the carrier to an inner door panel. In particular, in some cases, small openings and small radii curvature about the openings are desired to facilitate fixing the carrier to the inner door panel, however, lightweight materials typically do not provide an ability to form such small openings and small radii of curvature. Further yet, typical accessories, such as fasteners, including bolts and screws, do not work well with lightweight materials due to the lightweight materials being easily torn, and can be difficult to remove at end of life during recycling.

Carrier modules of vehicle closure panels can be made of sustainable materials and can be recycled during end of life processing. Because the forming process of a sustainable carrier can limit the ability to include extreme features such as those that are typically achieved in an injection molding process (such as mounting bosses or cable clips), accessories to the carrier have to be attached and have to be formed separately. At the end of life for the carrier, the accessories need to be removed in order to recapture and reuse the sustainable material.

In view of the above, there is a need to provide a carrier that is environmentally friendly, environmentally sustainable and biodegradable, while at the same time being able to perform desired structural and barrier functions without becoming damaged upon experiencing a high impact force, that allows for removal of accessories at the end of life of the carrier, and that enhances economies of manufacture and assembly, while reducing weight to enhance fuel economy of the vehicle.

### SUMMARY

This section provides a general summary of the disclosure and is not intended to be considered a complete and comprehensive listing of the disclosure's full scope or all of its aspects, advantages, objectives and/or features.

It is an object of the present disclosure to provide a carrier for a carrier module of a door assembly of a motor vehicle that addresses at least those issues discussed above of known carriers.

It is another object of the present disclosure to provide a sustainable carrier for a carrier module of a door assembly of a motor vehicle that allows for the attachment of accessories for use during the useful life of the motor vehicle and subsequent removable of the accessories to allow recapture and recycles of the sustainable material at the end of life of the carrier.

It is another object of the present disclosure to provide a carrier for a carrier module of a door assembly of a motor vehicle that is readily recyclable, environmentally sustainable, environmentally friendly, has high structural strength, is resistant to moisture and fluid penetration, thereby providing desired barrier function to prevent the transfer of moisture/fluid from a wet side of the carrier module to a dry side of the carrier module, is resistant to degradation in the presence of moisture/fluid, and reduces weight of the carrier module relative to those made of metal or plastic, thereby enhancing fuel economy of the vehicle.

According to one non-limiting aspect of the disclosure, a carrier for a carrier module of a motor vehicle door assembly having an inner panel and an outer panel defining a door panel structure with the inner panel having an opening to an internal door cavity between the inner panel and the outer panel, is provided. The carrier includes a carrier body formed from non-synthetic material. The carrier body is configured for attachment to the door panel structure. An aperture extends through the carrier body. The carrier further includes a projecting attachment feature, formed separately from the carrier body, of molded polymeric material. The projecting attachment feature has a bore aligned with the aperture, wherein a fastener extends through the aperture of the carrier body into the bore to secure the projecting attachment feature to the carrier body. The carrier further includes an accessory component operably secured to the attachment feature and to the carrier body, wherein the attachment feature, fastener, and accessory component are removable from the carrier body during end of the life processing, such that the carrier body can undergo end of life recycling free from metal or plastic, thereby avoiding contaminating the recycled material with metal or plastic, and further avoiding causing damage to any recycle equipment, such as comminuting blades, for example.

In accordance with another non-limiting aspect of the disclosure, the carrier body is formed entirely from non-synthetic environmentally sustainable material.

In accordance with another non-limiting aspect of the disclosure, the carrier body has a wet side and a dry side, and the accessory component and the attachment feature are on opposite sides of the carrier body.

In accordance with another non-limiting aspect of the disclosure, the accessory component includes a mount bracket having an aperture, the fastener extending through the aperture.

In accordance with another non-limiting aspect of the disclosure, the mount bracket is on the wet side.

In accordance with another non-limiting aspect of the disclosure, the carrier body has a wet side and a dry side, and the accessory component and the attachment feature are on the same side of the carrier body.

In accordance with another non-limiting aspect of the disclosure, the attachment feature has a base portion arranged in engagement with the carrier body and a pair of finger portions extending away from the base portion, the pair of finger portions configured to capture the accessory component therebetween.

In accordance with another non-limiting aspect of the disclosure, at least one of the pair of finger portions has a protrusion extending toward the other of the pair of finger portions.

In accordance with another non-limiting aspect of the disclosure, each of the pair of finger portions has a protrusion extending toward the other of the pair of finger portions.

In accordance with another non-limiting aspect of the disclosure, the base portion and the pair of finger portions are co-molded with one another.

In accordance with another non-limiting aspect of the disclosure, a carrier body can be constructed having a textile layer and a polymeric material bonded to and cured on at least one of a wet side and a dry side of the textile layer. At least one polymeric insert is fixed to the carrier body via the cured polymeric material.

In accordance with another non-limiting aspect of the disclosure, a carrier includes a body formed from sustainable material having opposite dry and wet sides bounded by an outer periphery configured for attachment to the inner panel to substantially close off the opening of the inner panel. The body has a plurality of openings adjacent the outer periphery. A clip assembly is fixed in each of the plurality of openings. The clip assembly includes an annular clip insert having an inner surface and an outer surface bounded by an outer periphery. The outer periphery of the annular clip insert is fixed in a corresponding one of the plurality of openings and has an inner periphery bounding an aperture. The clip assembly further includes a clip having a flange confronting the inner surface of the annular clip insert and a protrusion extending outwardly from the flange through the aperture. The protrusion has at least one locking feature configured to engage an outwardly facing surface of the inner panel to fix the carrier against removal from the inner panel.

In accordance with another non-limiting aspect of the disclosure, the protrusion has at least one cam feature configured for camming engagement with the annular clip insert outer surface causing the flange to compress against the dry side of the carrier.

In accordance with another non-limiting aspect of the disclosure, a first annular seal can be provided to extend outwardly from the outer surface adjacent the outer periphery of the annular clip insert, the first annular seal being compressed in sealing engagement against the dry side of the body.

In accordance with another non-limiting aspect of the disclosure, a second annular seal can be provided to extend outwardly from the flange of the clip, the second annular seal being compressed in sealing engagement against the inner surface of the annular clip insert.

In accordance with another non-limiting aspect of the disclosure, the clip is configured to lock with the inner panel and the annular clip insert to fix the carrier against removal from the inner panel upon rotation of the clip 90 degrees within the aperture.

In accordance with another non-limiting aspect of the disclosure, a carrier for a carrier module of a motor vehicle door assembly having an inner panel and an outer panel defining a door panel structure with the inner panel having an opening to an internal door cavity between the inner panel and the outer panel, includes a carrier body having a wet side and an opposite dry side bounded by an outer periphery configured for attachment to the inner panel to at least partially close off the opening. The carrier body has at least one polymeric insert fixed thereto, and further includes a textile layer and a polymeric material bonded to and cured on at least one of the wet side and the dry side of the textile layer. The at least one insert is fixed to the carrier body via the cured polymeric material.

In accordance with another non-limiting aspect of the disclosure, the textile layer is a natural fibrous non-woven layer.

In accordance with another non-limiting aspect of the disclosure, the nature fibrous non-woven layer is hemp.

In accordance with another non-limiting aspect of the disclosure, the polymeric material is polyurethane.

In accordance with another non-limiting aspect of the disclosure, the polymeric material is coated over the entirety of the wet side and the dry side.

In accordance with another non-limiting aspect of the disclosure, the at least one insert includes an insert fixed to the wet side and an insert fixed to the dry side.

In accordance with another non-limiting aspect of the disclosure, the at least one insert is polyurethane.

In accordance with another non-limiting aspect of the disclosure, a method of constructing a carrier for a carrier module of a motor vehicle door assembly is provided. The method includes providing a textile layer having planar opposite sides and applying a polymeric material to at least one of the opposite sides. Further, pressing the textile layer and polymeric material in a mold to attain a non-planar pressed contour. Further, pressing at least one insert into the polymeric material while pressing the textile layer and polymeric material, and then, curing the polymeric material to maintain the textile layer in the non-planar pressed contour and to fix the at least one insert to the polymeric material.

In accordance with another non-limiting aspect of the disclosure, the method can further include applying the polymeric material to each of the opposite sides and fixing at least one insert to the polymeric material on each of the opposite sides.

In accordance with another non-limiting aspect of the disclosure, the method can further include providing the polymeric material as polyurethane.

In accordance with another non-limiting aspect of the disclosure, the method can further include providing the at least one insert made of polyurethane.

In accordance with another non-limiting aspect of the disclosure, the method can further include applying the polymeric material in a spraying process.

In accordance with another aspect, the method can further include applying a sealing bead about an outer periphery of the textile layer while the textile layer is in the mold.

Further areas of applicability will become apparent from the description provided herein. The description and specific examples in this summary are only intended to illustrate certain non-limiting embodiments which are not intended to limit the scope of the present disclosure.

### BRIEF DESCRIPTION OF THE DRAWINGS

The drawings described herein are for illustrative purposes only of selected non-limiting embodiments and are not intended to limit the scope of the present disclosure. In this regard the drawings include:

FIG. 1 illustrates a motor vehicle with a door assembly constructed in accordance with one aspect of the disclosure;

FIG. 2 is a schematic elevation view of a door assembly of the vehicle of FIG. 1 having a carrier module in accordance with another aspect of the disclosure;

FIG. 3 illustrates a progression of three step used in forming a body of a carrier of the carrier module in accordance with one aspect of the disclosure;

FIG. 4 is a fragmentary view of the carrier illustrating an opening in the carrier with a clip assembly shown exploded for insertion into the opening to fix the carrier to an inner panel of the door assembly;

FIG. 5 is a perspective view of an annular clip insert of the clip assembly;

FIG. 6 is a view similar to FIG. 4 illustrating the clip assembly installed within the opening of the carrier;

FIG. 7 illustrates a dry side of a carrier of a carrier module in accordance with an aspect of the disclosure;

FIG. 8 illustrates a wet side of the carrier of FIG. 7;

FIG. 9A is a schematic elevation view illustrating an insert positioned to be pressed into an uncured polymeric layer of the carrier;

FIG. 9B is a schematic elevation view illustrating the insert pressed into the uncured polymeric layer of the carrier;

FIG. 10A is a schematic elevation view illustrating upper and lower mold halves spaced from one another with the carrier disposed therebetween prior to being pressed between the mold halves, with the upper mold half having injection ports aligned with injection nozzles and further including inserts releasable coupled thereto;

FIG. 10B is a view similar to FIG. 10A illustrating the mold halves closed into pressing engagement with the carrier with the injection nozzles positioned for injection of a sealing bead material through the injection ports;

FIG. 10C is a view similar to FIG. 10A illustrating the carrier after being pressed into a desired contour, shown schematically as planar, though non-planar contours are contemplated herein, with the inserts released from the upper mold half and fixed to a polymeric layer of the carrier, and with a sealing bead formed about an outer periphery of the carrier via injection of the sealing bead material through the injection ports;

FIG. 11 is a perspective inside view of a mold half in accordance with a non-limiting aspect of the disclosure having an insert releasably coupled thereto for transfer to the carrier during a pressing/stamping operation, and illustrating a sealing bead as injected during the pressing/stamping operation;

FIG. 12 is an enlarged, fragmentary view illustrating a non-limiting embodiment insert releasably coupled in a mold half similar to that depicted in FIG. 11;

FIG. 13 is a schematic exploded view of an accessory attachment arrangement for a sustainable carrier body in accordance with another aspect of the disclosure;

FIG. 14 is a schematic assembled view of the arrangement of FIG. 13;

FIG. 15 is a schematic assembled view of another accessory attachment arrangement for a sustainable carrier body; and

FIG. 16 is a schematic view of a press tool and resulting undulating sustainable carrier body.

### DETAILED DESCRIPTION OF EXAMPLE EMBODIMENTS

In general, example embodiments of a carrier for a carrier module of a motor vehicle, of the type configured including window regulators to be installed within an internal door cavity of a motor vehicle door assembly and having a carrier configured to separate a wet side from a dry side of the door assembly, constructed/manufactured in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

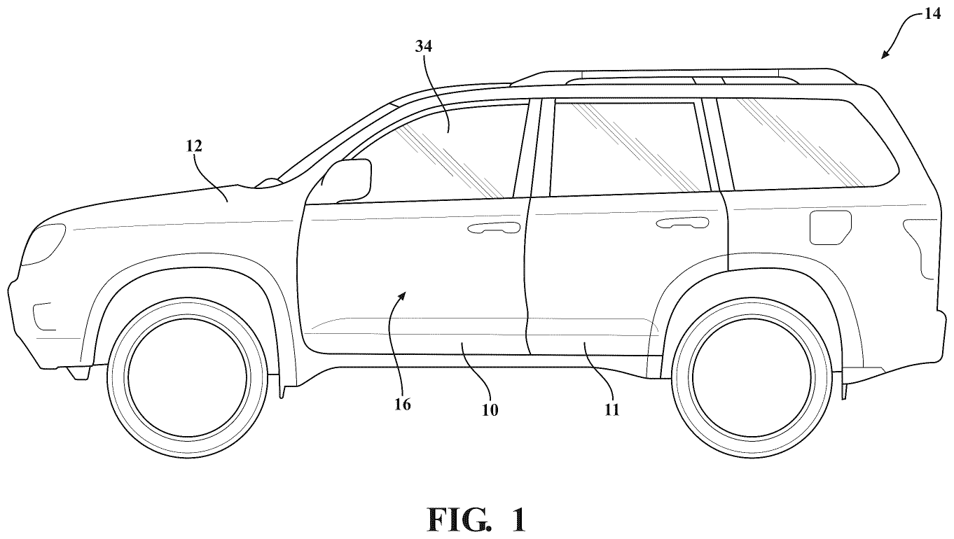

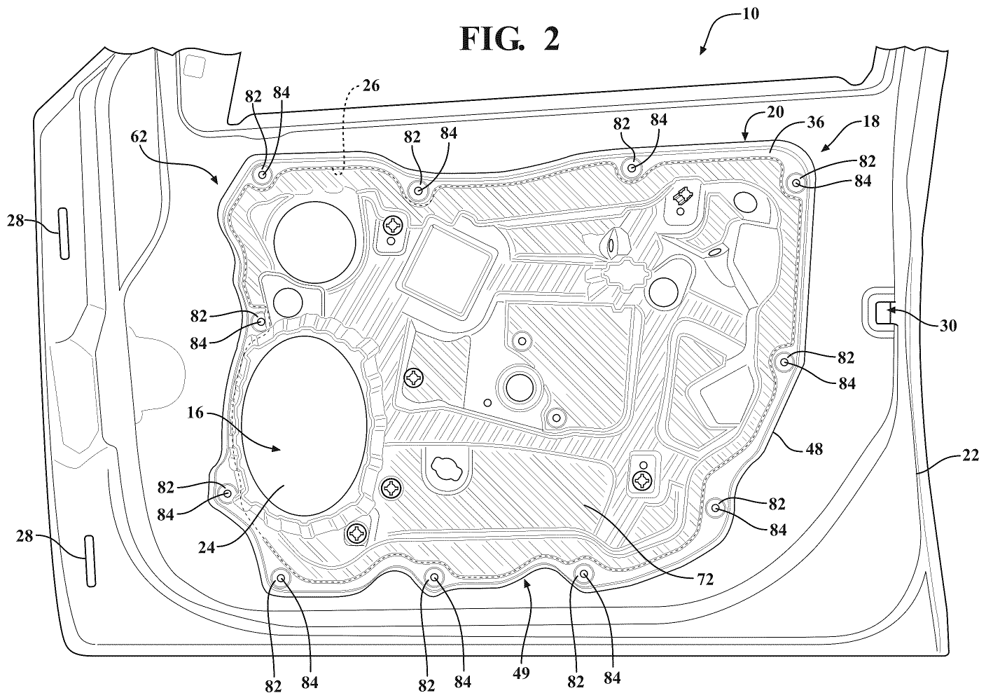

Reference is made to FIG. 1, which shows a door assembly 10 mounted to a vehicle body 12 of a motor vehicle 14. The door assembly 10 includes an outer panel 16, an inner panel 18 (FIG. 2) and a carrier assembly, referred to hereafter as carrier module 20, having a carrier 21 constructed in accordance with one presently preferred aspect of the disclosure. The manufacture, assembly, reduced weight, and performance of the door assembly 10 are enhanced directly as a result of the structure of the carrier 21. Further, the carrier 21 is also environmentally friendly, environmentally sustainable and biodegradable. It will be appreciated by the skilled artisan that the carrier module 20 and carrier 21 thereof can be incorporated into a rear passenger door assembly 11 or any other closure panel desired.

The outer panel 16 forms at least part of the exterior surface of the door assembly 10. The inner panel 18 provides a structural member for the mounting of one or more trim pieces that form an inner surface of the door assembly 10. Some of the inner panel 18 may itself also form part of the inner surface of the door assembly 10, if desired. The outer and inner panels 16, 18 are connected together to provide a door panel structure 22 that forms an internal door cavity 24 that contains various components of the door assembly 10, including components of the carrier module 20. To facilitate assembly of the components into the cavity 24, the inner panel 18 has at least one opening 26 (FIG. 2). The opening 26 is sized to allow access to the cavity 24 as necessary and desired for assembly and service of components therein, as is known.

The outer and inner panels 16, 18 may be made from any suitable material or combination of materials. For example, the outer and inner panels 16, 18 may both be made from a suitable metal (e.g. a suitable steel). In another example, the outer panel 16 may be made from a suitable polymeric or composite material (e.g. fiberglass) and the inner panel may be made from a suitable metal, by way of example and without limitation.

A pair of hinges 28 are connected to door panel structure 22 and pivotally mount a front end of door panel structure 22 (and door assembly 10) to the vehicle body 12. A door latch 30 is mounted to the rear end of door panel structure 22 to permit the releasable closure of door assembly 10 against vehicle body 12, as is known. Hinges 28 and door latch 30 act as force transfer members through which forces in door assembly 10 are transmitted to vehicle body 12. Such forces include, for example, side-impact forces from another vehicle or object colliding with the vehicle 14.

Carrier 21, as discussed further below, is configured for sealed mounting to inner panel 18 and to support a plurality of door hardware components, such as window and door latch components, including a power-operated window regulator having an electric motor-driven cable, pulleys, and lifter plates for moving a window 34 within glass run channels, by way of example and without limitation, as will be understood by one possessing ordinary skill in the vehicle door assembly art.

In accordance with a non-limiting embodiment, carrier 21 can be formed to function both as a fluid (water and moisture) barrier and as a sound barrier, and can be provided as a single-piece panel configured to receive a plurality of the aforementioned powered actuators and door hardware components in integrally formed contoured pockets. The carrier 21 is configured to be installed in fixed attachment to a surface of the inner panel 18 upon fixing the various components, such as those discussed above, in the internal door cavity 22. Further, in order to facilitate assembly, including ensuring the carrier 21 is properly located and fixed in sealed relation relative to the inner panel 18, the carrier 21 can be formed including a peripherally extending seal bead 36. The seal bead 36 can be provided as any suitable continuous bead of elastomeric and/or adhesive material capable of maintaining a fluid-tight seal between the carrier 21 and an outer surface of the inner panel 18, such as butyl, by way of example and without limitation.

Carrier 21 is formed from a recyclable, environmentally sustainable (the quality of not being harmful to the environment or depleting natural resources, and thereby supporting long-term ecological balance), biodegradable material, such as from natural fibers (NF) of natural fibrous material(s) (NF′). Furthermore carrier 21 is formed using sustainable and material renewable materials, such as plant fibers and rock fibers. The carrier 21 of the present disclosure is distinguished from known carriers formed from non-sustainable and non-renewable materials such as petroleum based materials requiring man-made chemical processes, such as chemical synthesis for example, to create forms of synthetic materials and synthetic fibres such as polymers and plastics, such as thermoplastics, for forming a carrier. Some well suited natural fibrous materials (NF′) include various types of natural fibers (NF), for example plant based fibers, such as bast fibers, cellulosic fibers, cane fibers, including kenaf, hemp, flax, bamboo, and jute, by way of example and without limitation. Such materials may be derived from plants or rocks for example. Other examples of natural fibrous materials (NF′) may also be a rock based material, such as basalt fibers. Further, being made entirely or substantially (nearly entirely, such as between 90-99.9 percent-by-weight (%/wt), and more preferably between 95-99.9%/wt, the carrier 21 is lightweight (20 percent of lighter than a similarly sized and shaped carrier of polypropylene (PP)), has high strength, particularly if the natural fibrous material (NF′) is kept dry, is 100% recyclable, 100% renewable, and 100% biodegradable, has a low content of volatile organic compounds (VOC) and is formaldehyde free, functions excellent as acoustic insulation, and exhibits a high heat stability up to temperatures of 220 degrees Centigrade (° C.). Carrier 21 may in one possible configuration be formed using the teachings of US Patent Application No. US20210300161A1 titled “Composite Structure for high strength door module and method”, the entire contents of which are incorporated herein by reference.

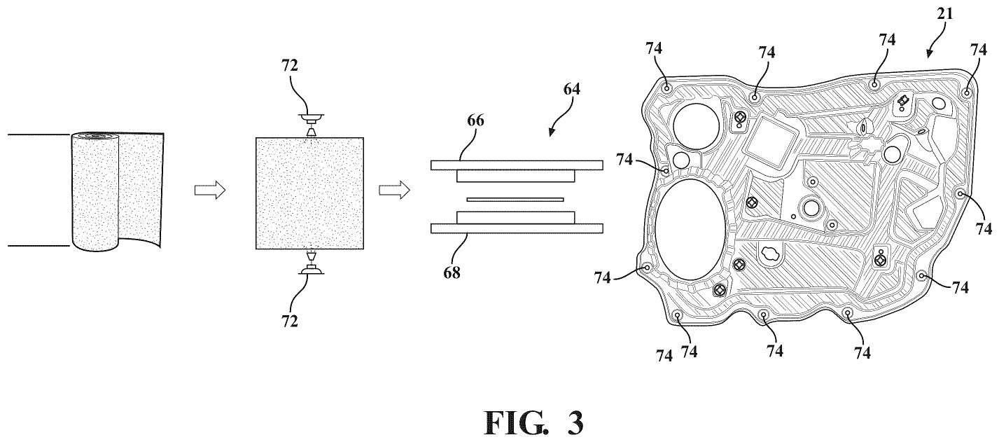

Carrier 21 has a body 49 has opposite sides, including a wet side 60 and a dry side 62, bounded by outer periphery 48. Body 49, aside from being formed of the aforementioned natural fibers of natural fibrous material, includes bonder additive, also referred to as binder, wherein binder facilitates bonding the natural fibers of natural fibrous material together. Binder can be provided as an additive in a non-woven web forming process, such as an air-laying process, by way of example and without limitation, whereupon web can be subjected to a suitable heat-treatment process to causes binder to melt and bond the natural fibers within web together. In addition to applying heat to melt binder, the web can be subjected to pressure, such as in a compression molding process (FIG. 3). Compression molding process utilizes mold assembly, e.g. tool press 64, having a male mold half 66 and a female mold half 68. Male mold half 66 includes outwardly extending protrusions and female mold half 68 includes cavities, wherein protrusions and cavities mirror and mate with one another in nesting relation to form the desired non-planar features of carrier 21. It is contemplated that the binder can be provided to bond the natural fibers of natural fibrous material together without heat, wherein binder can be provided as a suitable adhesive.

A fluid impervious sealant material or water barrier, also referred to as water layer or layer 72, can be applied/fixed to as least one of the opposite sides 60, 62 of body 49, and preferably to at least the wet side 60 to prevent moisture or fluid on the wet side of carrier module 20 from reaching the natural fibrous material of the body 49. If desired, the layer 72 can be provided as a preformed solid sheet of sealant material, such as a polymeric material, e.g. polyurethane, that is subsequently fixed to the wet side 60 and optionally to the dry side 62, such an adhesive and/or mechanical fastener. Layer 72 can also be applied via a spraying (FIG. 3), dipping, or other coating process either prior performing the molding operation and/or after performing the molding operation.

Body 49 is formed having a plurality of fastener through openings, referred to as openings 74 (FIG. 3), adjacent the outer periphery 48. The openings 74 can be formed having a relative small diameter, such as between about 5-50 mm, and more preferably between about 10-25 mm, depending on the size of fastener, also referred to as clip assembly 80, discussed hereafter, being used to attach carrier 21 to door panel structure 22. Openings 74 are formed simply as openings, and not having any peripheral contours, but rather, simply as openings 74 extending through the thickness of the generally flat body 49. Openings 74 are formed having a circumferentially continuous periphery bounding the opening 74, and are formed at strategic, predetermined locations about the outer periphery 48 to locate the clip assemblies 80 in a desired position for fixation to the inner panel 18, such as within preformed through openings in the inner panel 18.

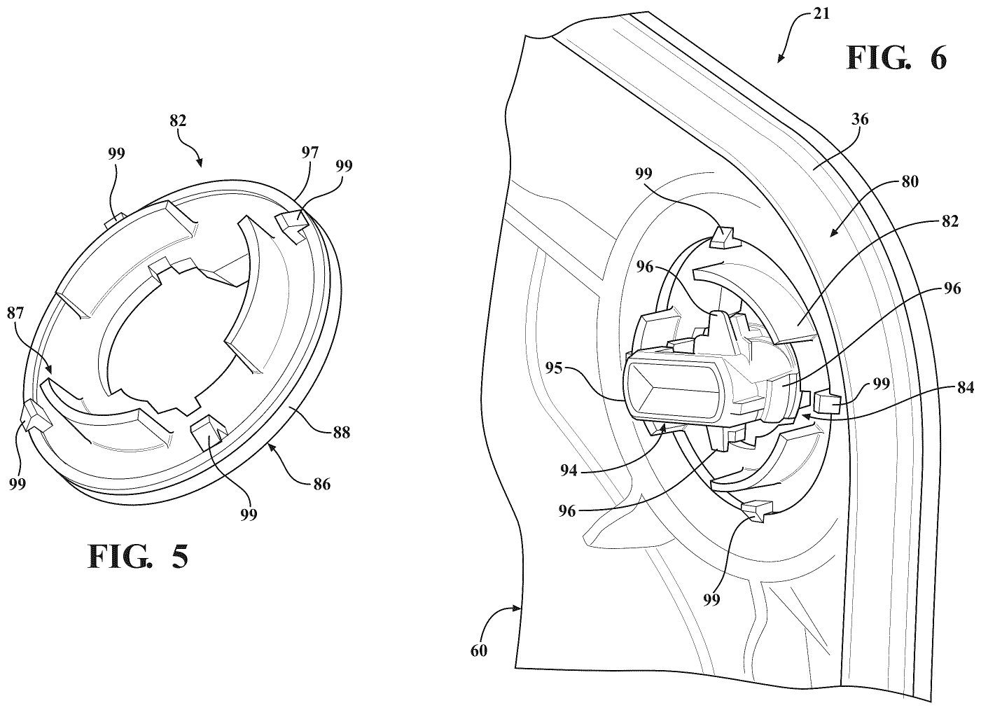

The clip assemblies 80 are fixed in each of the plurality of openings 74, and include an annular clip insert 82 and a clip 84. The annular clip insert 82, as best shown in FIG. 5, has an inner surface 86 (inner being denoted as facing an inside passenger cabin of motor vehicle 14) and an outer surface 87 (outer being denoted as facing an exterior of motor vehicle 14) bounded by an outer periphery 88. The outer periphery 88 is fixed in a corresponding one of the plurality of openings 74 and an inner periphery 89 bounds a through opening, also referred to as aperture 90.

Clip 84 has a flange 92 configured to confront, also referred to as abut, the inner surface 86. Clip 84 further has a fastener portion, referred to as protrusion 94, extending outwardly from the flange 92 along an axis A for insertion through the aperture 90 upon fixation of the carrier 21 to inner panel 18. The protrusion 94 has at least one locking feature 95 facing radially outwardly from axis A, with locking feature 95 being configured to engage an outwardly facing surface (facing away from the motor vehicle cabin and facing the exterior of motor vehicle 14) of the inner panel 18 to fix the carrier 21 against removal from the inner panel 18. Protrusion 94 has at least one cam feature 96 configured for camming engagement with the annular clip insert outer surface 87 to cause the flange 92 to compress against the dry side 62 of the carrier 21 while fastening the carrier 21 to the inner panel 18.

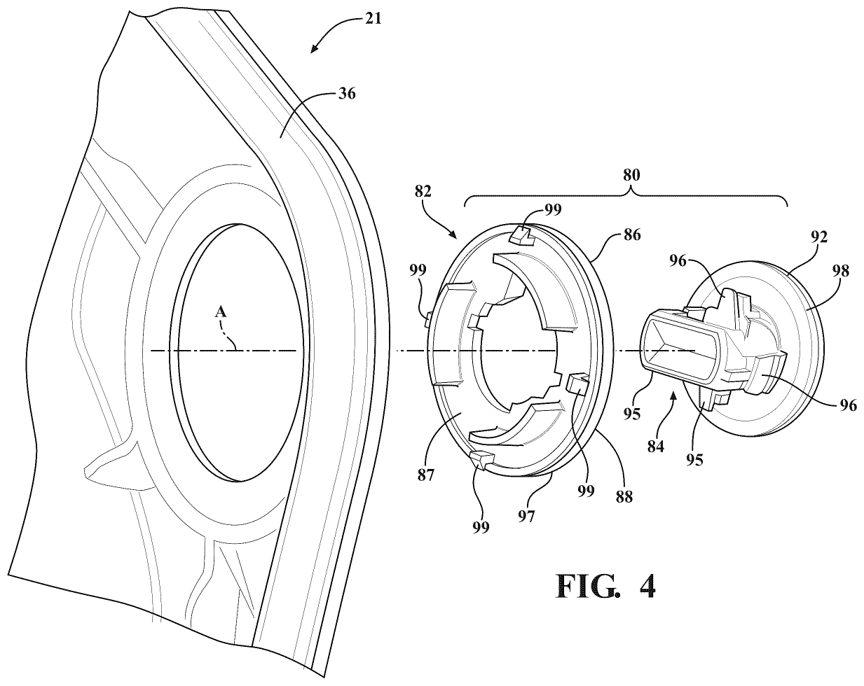

To facilitate forming a water tight seal between the annular clip insert 82 and the carrier 18, a first annular seal 97 (FIGS. 4 and 5) is provided to extend outwardly from the outer surface 88 adjacent the outer periphery 88 of the annular clip insert 82. During assembly, the first annular seal 97 is compressed in sealing engagement against the dry side 62 of the carrier body 49. The annular seal 97 can be formed of any suitable elastomeric, polymeric seal material, and can be overmolded or otherwise attached to the outer surface 87 of the flange 92.

To facilitate forming a water tight seal between the clip 84 and the annular clip insert 82, a second annular seal 98 (FIG. 4) is provided to extend outwardly along the direction of axis A from the flange 92 of the clip 84. During assembly, the second annular seal 98 is compressed in sealing engagement against the inner surface 86 of the annular clip insert 82. Accordingly, with the first seal 97 forming a water-tight seal between the annular clip insert 82 and the carrier 21, and the second annular seal 98 forming a water-tight seal between the clip 84 and the annular clip insert 82, a complete water-tight seal is formed between the clip assembly 80 and the carrier 21.

During assembly, the annular clip insert 82 can first be fixed to the carrier 21, wherein a plurality of snap members, also referred to as snap clips, spring fingers, or clip fingers 99, are pressed through the openings 74 to snappingly fix the annular clip insert 82 to the carrier 21, whereupon the first annular seal 97 forms the sealed engagement with the dry side 62 of the carrier 21. Then, the protrusion 94 of clip 84 is inserted through the aperture 90 of annular clip insert 82 and into the fastener through openings 74. Upon insertion of clip 84 into the fastener through openings 74, clip 84 is rotated about axis A, such as between about 10 and 180 degrees, and in one presently preferred embodiment, about 90 degrees, thereby causing cammed engagement of cam features 96 with the outer surface 87 of annular clip insert 82. The camming causes sealing compression of the first annular seal 97 with the dry side 62 of carrier 18 and sealing compression of the second annular seal 98 with the inner surface 86 of annular clip insert 82. Further, the rotation of clip 84 causes locking engagement of locking features 95 with the outwardly facing surface of inner panel 18. As such, a quick, reliable mechanism is performed to reliably fix carrier 21 to inner panel 18 in sealed relation therewith.

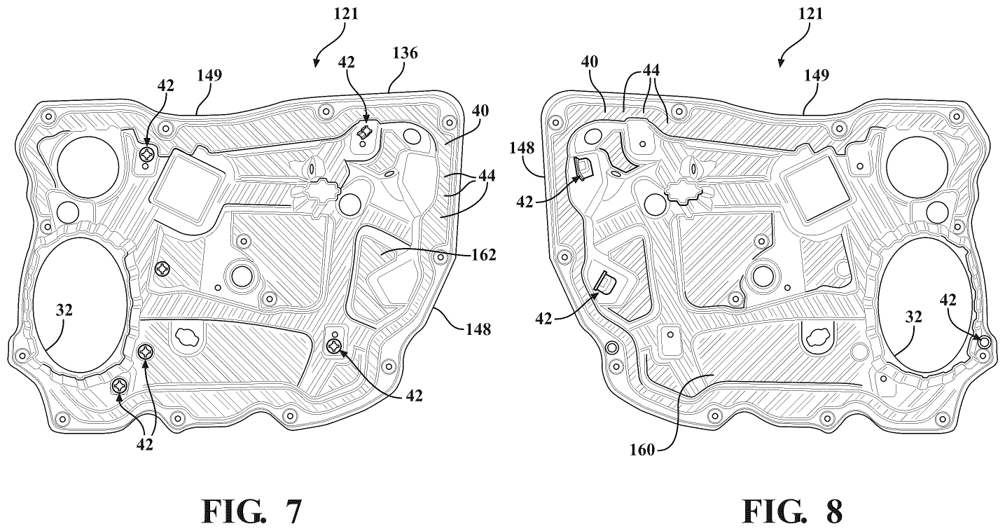

FIGS. 7 and 8 illustrate an environmentally friendly, reclaimable and sustainable carrier plate, referred to hereafter as carrier 121, constructed in accordance with another aspect of the disclosure. FIG. 7 shows a first side 162 (dry-side) of the carrier 121, while FIG. 8 shows a second side 160 (wet-side) of carrier 121. The first side 162 of the carrier 121 is referred to as the “dry-side” because, when carrier 121 is installed in a vehicle closure panel of the motor vehicle, the carrier 121 seals a passenger compartment, also referred to as an interior cabin, of the motor vehicle against the ambient external environment such that the first side 121, which faces toward the interior cabin, is protected from the external environment and remains dry. In contrast, the second side 162 of the carrier 121 is referred to as the “wet-side” because, when the carrier 121 is installed in the vehicle closure panel of motor vehicle, the second side 162 faces outwardly, away from the interior cabin, and may be exposed to the ambient external environment as a result of apertures in the panel assembly (such as the large slot through which a window moves between open and closed positions). It is to be recognized that the carrier 121 can be configured having any non-planar surface contours and outer peripheral shape as desired for application with any closure panel assemblies, as well as for other applications, including, but not limited to deck lids and the like.

Carrier 121, in accordance with aspects of the disclosure, can be readily formed having a combination of planar and non-planar, undulating contours, also referred collectively as surface profiles, provided as desired for the intended components and application, thereby providing the carrier 121 having a variety of integrally formed three-dimensional features within the material of the carrier 121, which includes a textile layer 38 and at least one, and shown as a pair of opposite layers of polymeric material 40 covering opposite sides of the textile layer 38. Carrier 121 holds a variety of functional door hardware components, and as such, is provided having at least one, and shown as a plurality of integrally fixed inserts 42 fixed to carrier 121 via the polymeric material 40. Carrier 121 can be formed as a structural component in the sense that the door hardware components may be mounted to the inserts 42 without requiring additional fasteners to mount the components to the structural door panel assembly after installation of carrier 121 therein. Carrier 121 includes a circumferentially, continuously extending sealing bead 136 which is configured to extend adjacent an outer periphery 148 of carrier 121 and surround an opening in inner door panel (not shown) in sealed relation thereabout when carrier 121 is assembled and mounted against inner door panel. Accordingly, the carrier 121 at least partially or entirely closes off the opening of the inner door panel, as desired. Since carrier 121 is impervious to water, as rendered by the polymeric material 40, the sealing bead 136 acts to prevent infiltration of debris and other forms of contamination, including fluid and moisture, from the wet side 160 to the dry side 162 into the passenger interior cabin.

Generally speaking, the functional hardware components secured to carrier 121 can include, by way of example and without limitation, a power-operated latch assembly, a power-operated window regulator, an inside handle unit mechanically coupled to latch assembly via an inside release mechanism and via an inside lock/unlock mechanism, and an outside handle unit mechanically coupled to latch assembly via an outside release mechanism. Carrier 121 can further support a pair of guide rails which support corresponding lift brackets for translational movement thereon. Lift brackets support a window for movement along rails between opened and closed positions. A cable and pulley-type window lift system connects lift brackets to a drum associated with power-operated window regulator. In addition to the door hardware components, carrier 121 is further shown, by way of example and without limitation, for supporting a speaker of a vehicle sound/entertainment system within a speaker opening 32 in a manner that optimizes the performance of the speaker, while resolving concern for privacy and sound transmission issues with regard to carrier 121.

Carrier 121 has a carrier body 149 providing the wet side 160 and the opposite dry side 162 bounded by the outer periphery 148 configured for attachment to the inner panel to at least partially close off the opening. The carrier body 149 includes textile layer 38 and polymeric material 40, with polymeric material 40 bonded to and cured on at least one of the wet side 160 and the dry side 162 of the textile layer 38, and shown as being bonded to and cured on both sides 160, 162. The inserts 42 are fixed to carrier body 149 via the cured polymeric material 40 during the curing process used to cure polymeric material 40.

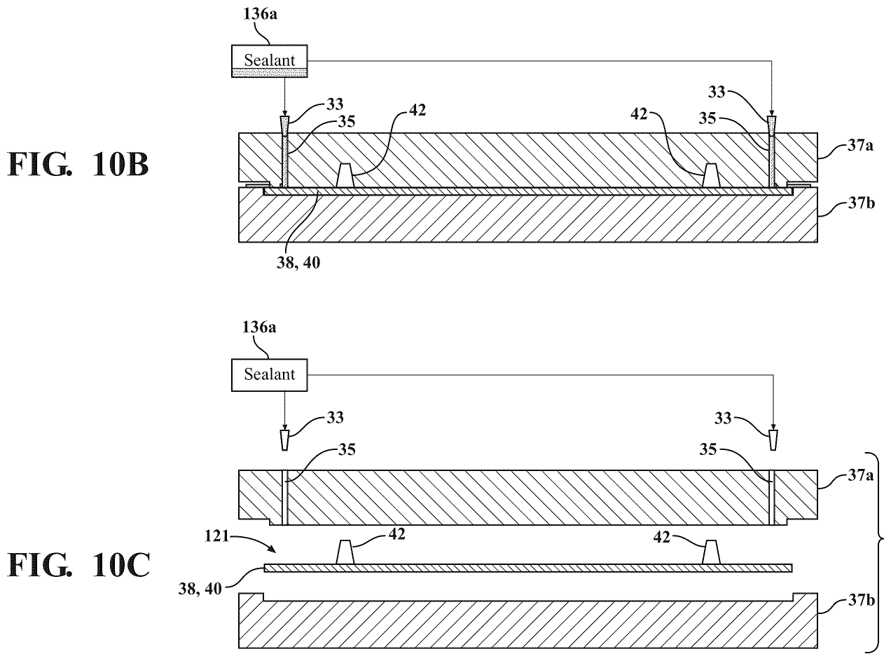

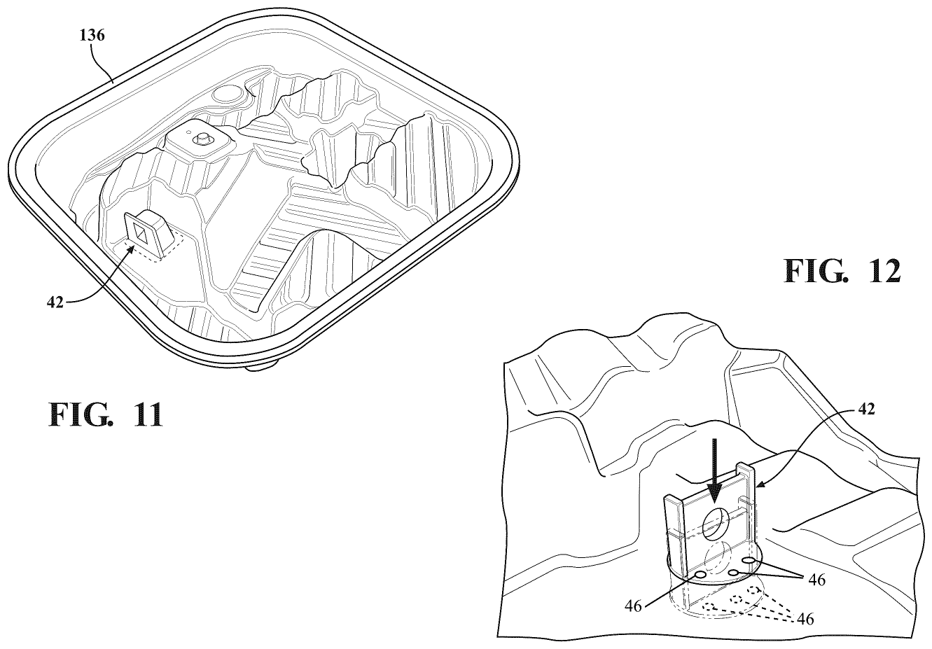

The textile layer 38 is initially provided as sheet of a natural fibrous non-woven layer, such as from hemp, by way of example and without limitation. During a pressing/stamping/molding operation, as shown in FIGS. 10A through 10C, the textile layer 38 and polymeric material 40 thereon are formed to take on any desired contour profile, as discussed above. The profile can include a plurality of undulating ribs 44 to enhance the strength and rigidity of carrier 121.

The polymeric material 40 can be provided as polyurethane, wherein the polymeric material 40 can be coated, such as in a spraying operation, by way of example and without limitation, over the entirety of the wet side 160 and the dry side 162.

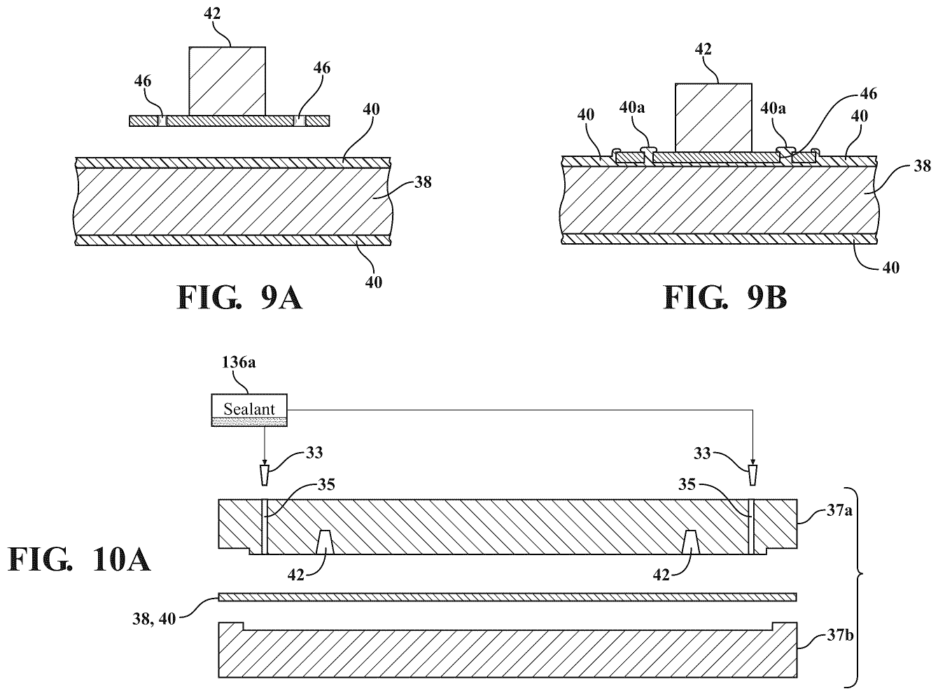

The inserts 42 are shown fixed to the wet side 160 and the dry side 162 via the cured polymeric material 40. To provide an enhanced bond strength between the inserts 42 and the polymeric material 40, which, as noted can be polyurethane, by way of example and without limitation, the inserts 42 can also be formed of polyurethane. As shown in FIGS. 9A, 9B, and 10A through 10C, the inserts 42 are pressed into the polymeric material 40 while the polymeric material 40 is first applied in an uncured state, and then, thereafter, with the inserts 42 disposed in the polymeric material 40, the polymeric material 40 is cured in a curing process to fix and lock the inserts 42 to the carrier body 49. The inserts 42 can be provided with one or more receptacles, also referred to as openings 46, for receipt of the uncured polymeric material 40 therein, such that the uncured polymeric material 40 can flow through the opening(s) 46 prior to being cured, and then, after curing, the polymeric material 40 can formed enlarged heads or flanges 40a (FIG. 3B) that function to mechanically lock the inserts 42 in fixed relation within the cured polymeric material 40.

During the forming operation, as shown in FIGS. 10A through 10C, while the pressing/stamping is taking place (FIG. 10B), the sealing bead 136 can be formed via injection of the sealing bead material 136a via injection nozzles 33 through ports 35 in one of the stamps, also referred to as mold halves 37a, 37b. The sealing bead material 20a can flow through the ports 35 and through a sealing bead channel, also referred to as cavity, formed in the mold half 37a to flow about the outer periphery 148 of the carrier 121, thereby forming the circumferentially continuous sealing bead 136. Accordingly, the sealing bead 136 is formed in the same operation as the pressing/stamping of the carrier body 149, thereby avoiding need for secondary operations at secondary stations.

In accordance with another aspect of the disclosure, a method of manufacturing a carrier 121 for a motor vehicle door panel body or at least partially or entirely closing off an opening in an inner door panel of the motor vehicle door panel body is provided to keep moisture and fluid from passing from a wet side 160 (facing exterior environment) of carrier 121 to a dry side 162 (facing an interior passenger cabin of motor vehicle) of carrier 121. The method includes a step providing a textile layer 38 having planar opposite sides; a step of applying a polymeric material 40 to at least one of the opposite sides; a step of pressing the textile layer 38 and polymeric material 40 in a mold 37a, 37b to attain a non-planar pressed contour; a step of pressing at least one insert 42 into the polymeric material 40 while pressing the textile layer 38 and polymeric material 40; and a step of curing the polymeric material 40 to maintain the textile layer 38 in the non-planar pressed contour and to fix the at least one insert 42 to the polymeric material 40.

In accordance with another aspect of the disclosure, the method can further include applying the polymeric material 40 to each of the opposite sides of the textile layer 38 and fixing at least one insert 42 to the polymeric material 40 on each of the opposite sides.

In accordance with another aspect of the disclosure, the method can further include providing the polymeric material 40 as polyurethane.

In accordance with another aspect of the disclosure, the method can further include providing the at least one insert 42 made of polyurethane and the polymeric material 40 of polyurethane.

In accordance with another aspect of the disclosure, the method can further include applying a sealing bead 136 about an outer periphery 148 of the textile layer 38 while the textile layer 38 is in the mold 37a, 37b.

In accordance with another aspect of the disclosure, the method can further include applying the polymeric material 40 to the textile layer 38 in a spraying process.

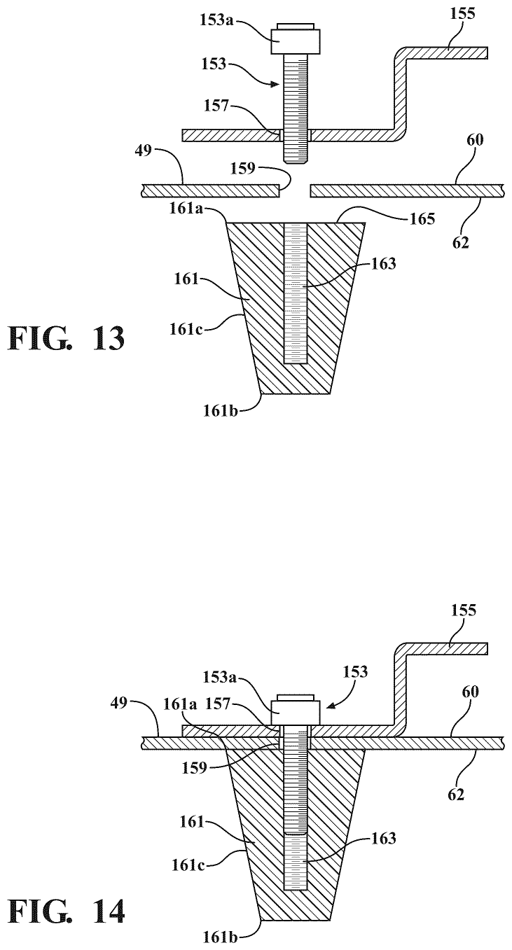

FIG. 13 illustrates an attachment arrangement for the carrier body 49 of carrier 21 (and alternative arrangements discussed above), in which an accessory component 155, such as a window regulator, by way of example and without limitation, having a support bracket 155, can be removably fixed to the wet side 60 of carrier body 49 (or its alternatives described above), which does not include an integral attachment feature, such as a co-molded attachment feature.

Accordingly, accessory component 155 is operably secured to the attachment feature 161. It is to be understood that the support bracket 155 discussed herein is considered to be a part of the accessory component 155, although the entirety of the accessory component 155, such as a window regulator, by way of example and without limitation, is not shown.

As described above, carrier body 49 is formed as a sustainable body. In one example, the carrier body 49 is a single layer organic, non-synthetic, non-woven fabric. The fabric may be formed of 100% non-synthetic material, such as from plant fiber (such as hemp, flax, bamboo, etc.), or can incorporate other natural source material (basalt), or post industrial (scraps from machine)/post consumer recycled material (end of life carrier plate material). The carrier body 49 may include a polyurethane spray that may be applied prior to being shaped or applied to a press tool, such as discussed above for carrier 149.

FIG. 13 illustrates one example of carrier body 49 having a substantially planar, single layer body having the wet side 60 and the dry side 62. It will be appreciated that the body 49 shape may differ from this substantially planar shape, and may include a non-flat curvature, for example, such as undulation or ribs 44 (FIGS. 7 and 8), as discussed above, in at least some locations. The carrier body 49 includes one or more through openings, also referred to as apertures 159, extending through the body 49 and allowing for the insertion of fastener 153. Fasteners 153 are configured to pass through a through opening, also referred to as aperture 157, of the support bracket 155 of the accessory component 155.

Unlike the carrier body 149, carrier body 49 does not include a co-molded and projecting attachment feature. Rather, the attachment arrangement of carrier body 49 includes separately provided attachment feature 161, which can be an attachment feature 161 formed of molded material.

Attachment feature 161 can be provided in the form of a separate piece of polymeric material in the form of a molded polymeric material, such as a plastic material. Attachment feature 161 may have a bore, shown as a blind bore 163 extending into a body thereof. Bore 163 may include internal threads, such as a helical thread, by way of example and without limitation, sized and arrange to engage external threads of fastener 153. Of course, it is contemplated that the inner wall bounding the bore 163 could be self-tapped with male threads of fastener 153, if desired.

The attachment feature 161 may have an outer surface having a tapered shape, shown as being frustoconical, with an upper end 161a being wider than a lower end 161b, with a conical outer surface 161c extending from the upper end 161a to the lower end 161b. The upper end 161a defines an upper mating surface 165, with the bore 163 extending downward through the upper mating surface 165 into the body of the attachment feature 161 toward the lower end 161b. The upper mating surface 165 is sized and arranged to mate with and engage a corresponding surface of the carrier body 49, shown as the dry side 62 of carrier body 49. Preferably, the aperture 159 in the carrier body 49 is equal in diameter or larger than the bore 163, and the aperture 159 is smaller than an outer periphery, such as a diameter, defined by the upper end 161a of the upper mating surface 165.

The attachment feature 161 is separately formed as a polymeric molded material, such as plastic, to facilitate forming the carrier body 49 and due to limitations in the forming process for the carrier body 49. For instance, protruding feature, such as a mounting boss or a wiring harness clip cannot be readily formed with the process used to create the environmentally sustainable carrier body 49. Thus, the attachment feature 161 can be made separately from the process used to construct the carrier body 49, and then be subsequently assembled to the carrier body 49.

In one example, the attachment feature 161 may be attached to the carrier body 49 via an adhesive, or mechanically joined with the carrier body 49 via mechanical fasteners, such as discussed above for fasteners 153. While the separate protruding attachment feature 161 can be a molded plastic, the plastic can contain recycled content, organic waste (UBQ), or natural fibers such as hemp.

The separate molded projection of the attachment feature 161 may be in the form of a single boss corresponding to the location of the aperture 159, in one aspect. The apertures 159 may be punched or otherwise formed in the carrier body 49 at various locations corresponding to the footprint of the openings in the mounting bracket 155 of the accessory component, e.g. window regulator. In another aspect the attachment feature 161 may be in the form of a molded rail or other structural support, depending on the accessory component being fixed to the carrier body 49. The cross-sectional views shown herein apply to various types of non-limiting overall shapes of the separate molded attachment feature 161.

FIG. 14 illustrates the arrangement of FIG. 13 in an assembled state, in which the mounting bracket 155 of the accessory component is secured to the carrier body 49. The separate molded attachment feature 161 is secured against the carrier body 49 at the location of the aperture 159, such that aperture 159 is aligned with the bore 163, and the fastener 153 extends into threaded engagement with the attachment feature 161 on the opposite side of the carrier 49. Accordingly, carrier body 49 is sandwiched in clamped, slightly compressed fashion between the mounting bracket 155 and the attachment feature 161, such that the accessory component 155 and the attachment feature 161 are on opposite sides of the carrier body 49. It is to be recognized that an enlarged head 153a of fastener 153 can be provided to engage an outwardly facing surface of mounting bracket 155 to cause the mounting bracket 155 to be drawn into compressed engagement with the carrier body 49 upon tightening fastener 153 into fixed engagement within bore 163 of attachment feature 161.

The above illustrated arrangement is effective to securably retain the accessory component, e.g. window regulator, having its existing mounting arrangement, even with the carrier 49 not including a co-molded mount feature, such as provided by injection molded plastic carriers. It will be appreciated that the carrier body 49 may include other features that are separately formed and attached thereto via the attachment feature 161, and which will likewise be removed prior to further processing.

At the end life of the carrier 21, the accessory component and mount bracket 155 thereof, and the attachment feature 161 can be easily separated and removed from the carrier body 49 during end of life processing. The fastener 153 is easily removed via a typical fastener removal process, where the fastener is removed from its engagement with the attachment feature 161 via a suitable tool (not shown). The fastener 153 may then be recycled, if possible. For example, a metal or nylon fastener 153 may be recycled according to existing processes. The attachment feature 161, with the fastener 161 removed, can then be separated from the carrier body 49.

With the carrier body 49 free of metal or plastic, the carrier body 49 can then be further processed for re-use. For example, the carrier body 49 may be shredded without fear of causing damage to the shredder blades and re-used as material for a new sustainable component, such as a new carrier body 49.

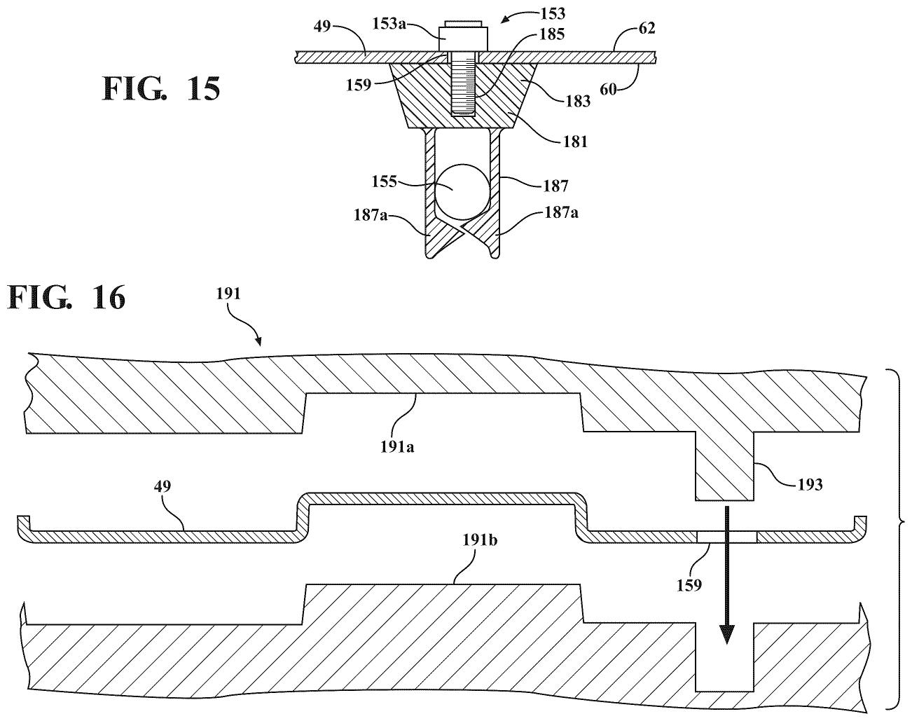

FIG. 15 illustrates another example of a separately formed attachment feature 181. In particular, FIG. 15 illustrates a separately formed attachment feature 181 in the form of a clip. Attachment feature 181 includes a base portion 183 sized and arranged to mate with the carrier body 49, such as discussed above for attachment feature 161. Base portion 183 includes a bore, shown as a blind bore 185, by way of example and without limitation, which aligns with the aperture 159 formed in the carrier body 49. The bore 185 is sized and configured to receive and engage fastener 153, similar to the arrangement of FIGS. 13 and 14.

However, in this non-limiting example, the fastener 153 does not secure a mounting bracket of an accessory component, such as discussed above for mounting bracket 155 of accessory component, e.g. a window regulator. Rather, the fastener 153 secures the attachment feature 181 to carrier body 49 via an enlarged head 153a of fastener 153 engaging one side of carrier body 49 and the attachment feature 181 engaging an opposite side of carrier body 49, with attachment feature 181 being directly coupled to the accessory component, e.g. window regulator. In the illustrated non-limiting embodiment, the attachment feature 181 further includes a pair of spring finger portions, also referred to as finger portions 187, that extend directly from the base portion 183 away from carrier body 49. The finger portions 187 may be provided to function as cable clips or the like, for directly capturing and securing the accessory component 155, such as a wiring harness or other elongate member, by way of example and without limitation, between the finger portions 187 of attachment feature 181. Accordingly, accessory component 155 is operably secured to the base portion 183 of attachment feature 181, such that the accessory component 155 and the attachment feature 181 are on the same side of the carrier body 49 with one another, shown as being on the wet side 60, by way of example and without limitation. It is contemplated that the finger portions 187 could be configured for attachment to a window regulator, or otherwise.

The base 183 and finger portions 187 may be co-formed, such as co-molded, or may be separate pieces that are subsequently secured together. By co-molded, it is intended to mean that the base 183 and finger portions 187 may be molded as a monolithic piece of material, such as plastic, or that the finger portions 187 may be overmolded in a mold cavity by injected material of the base portion 183 into the mold cavity. The base portion 183 and finger portions 187 are preferably a plastic material which are separately formed relative to the carrier 49, and which are secured to the carrier 49 via the fastener 153. Finger portions 187 are resilient, such that they may be biased away from one another under an externally applied force and then spring back into close relation with one another to capture the accessory component 155 therebetween. Accordingly, the accessory component 155 can be effectively snapped in captured relation between the finger portions 187. To facilitate capturing the accessory component 155, at least one of the spring finger portions 187 has a protrusion 187a extending toward the other of the spring finger portions 187, and in the non-limiting illustrated embodiment, each of the spring finger portions 187 has a protrusions 187a extending toward the other of the spring finger portions 187, with the protrusions 187a facing one another in abutment, and/or overlapping relation, or close relation with one another to facilitate capturing the accessory component between the spring fingers 187 of the attachment feature 181. Accordingly, the accessory component 155 can be effectively snapped passed the protrusions 187a, whereupon the spring fingers 187 deflect outwardly away from one another and then spring resiliently back toward one another to fix the accessory component 155 in captured relation between the finger portions 187, with the protrusions 187a acting to prevent unwanted release of the accessory component 155 from captured receipt between the spring fingers 187.

In another aspect, attachment features 161 and 181 may be combined, for example, with finger portions 187 extending from attachment feature 161, or with the fastener 153 and attachment feature 181 also securing support structure 155.

It will be appreciated that various sizes and shapes of separately molded plastic attachment features may be secured to the carrier 49 having one or more punched or otherwise formed apertures 159. The various attachment features 161, 181 may be also referred to generally as a separately molded projection feature, and may include the various structure necessary to cooperate with the corresponding structure of the accessory component that is to be secured to the carrier 49.

The various separately molded attachment features 161, 181 are removable from the carrier 49 during end of life process, as described above, with the carrier 49 undergoing further processing and recycling.

FIG. 16 illustrates a form of carrier body 49 having an undulating body rather than a substantially planar body. The undulating body may provide increased strength and bending resistance relative to a generally planar body. The undulating body shape may be defined via a press tool 191. The press tool 191 may include upper and lower plates 191a, 191b having features corresponding to the undulating shape to be created (for example, corresponding convex and concave sections that nest together with the carrier 49 disposed therebetween).

The press tool 191 may include one or more protruding punch 193, projecting from one of the plates, and being received in a corresponding pocket or recess 195 in the other of the plates. The punches 193 and recesses 195 may be disposed along the press tool 191 at multiple locations to define the necessary array of apertures 159 in the carrier 49 as determined based on the specific carrier design and accessory components that are to be attached. Thus, the apertures 159 and the undulating shape can be created in the same pressing step of the press tool 191.

While the above description constitutes a plurality of embodiments of the present invention, it will be appreciated that the present invention is subject to further modification and change without departing from the fair interpretation and intended meaning of the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A carrier for a carrier module of a motor vehicle door assembly having an inner panel and an outer panel defining a door panel structure with the inner panel having an opening to an internal door cavity between the inner panel and the outer panel, said carrier comprising:
a carrier body formed from non-synthetic material and configured for attachment to the door panel structure, an aperture extending through the carrier body;
a projecting attachment feature formed separately from the carrier body of molded polymeric material, the projecting attachment feature having a bore aligned with the aperture;
a fastener extending through the aperture of the carrier body into the bore and securing the projecting attachment feature to the carrier body; and
an accessory component operably secured to the attachment feature and to the carrier body,
wherein the attachment feature, fastener, and accessory component are removable from the carrier body during end of the life processing, wherein the carrier body can undergo end of life recycling free from metal or plastic.

2. The carrier of claim 1, wherein the carrier body is formed entirely from non-synthetic environmentally sustainable material.

3. The carrier of claim 1, wherein the carrier body has a wet side and a dry side, and the accessory component and the attachment feature are on opposite sides of the carrier body.

4. The carrier of claim 3, wherein the accessory component includes a mount bracket having an aperture, the fastener extending through the aperture.

5. The carrier of claim 4, wherein the mount bracket is on the wet side.

6. The carrier of claim 1, wherein the carrier body has a wet side and a dry side, and the accessory component and the attachment feature are on the same side of the carrier body.

7. The carrier of claim 6, wherein the attachment feature has a base portion arranged in engagement with the carrier body and a pair of finger portions extending away from the base portion, the pair of finger portions configured to capture the accessory component therebetween.

8. The carrier of claim 7, wherein at least one of the pair of finger portions has a protrusion extending toward the other of the pair of finger portions.

9. The carrier of claim 8, wherein each of the pair of finger portions has a protrusion extending toward the other of the pair of finger portions.

10. The carrier of claim 7, wherein the base portion and the pair of finger portions are co-molded with one another.

11. A carrier for a carrier module of a motor vehicle door assembly having an inner panel and an outer panel defining a door panel structure with the inner panel having an opening to an internal door cavity between the inner and outer panels, said carrier comprising:
a body formed from sustainable material having opposite dry and wet sides bounded by an outer periphery configured for attachment to the inner panel to substantially close off the opening, said body having a plurality of openings adjacent said outer periphery; and
a clip assembly fixed in each of said plurality of openings, said clip assembly including an annular clip insert having an inner surface and an outer surface bounded by an outer periphery, said outer periphery fixed in a corresponding one of said plurality of openings and an inner periphery bounding an aperture, and a clip having a flange confronting said inner surface and a protrusion extending outwardly from the flange through said aperture, said protrusion having at least one locking feature configured to engage an outwardly facing surface of said inner panel to fix said carrier against removal from said inner panel.

12. The carrier of claim 11, wherein said protrusion has at least one cam feature configured for camming engagement with said annular clip insert outer surface causing said flange to compress against said dry side of said carrier.

13. The carrier of claim 12, further including a first annular seal extending outwardly from said outer surface adjacent said outer periphery of said annular clip insert, said first annular seal being compressed in sealing engagement against said dry side of said body.

14. The carrier of claim 13, further including a second annular seal extending outwardly from said flange of said clip, said second annular seal being compressed in sealing engagement against said inner surface of said annular clip insert.

15. The carrier of claim 12, wherein said clip is configured to lock with said inner panel and said annular clip insert to fix said carrier against removal from said inner panel upon rotation of said clip 90 degrees within said aperture.

16. A carrier for a carrier module of a motor vehicle door assembly having an inner panel and an outer panel defining a door panel structure with the inner panel having an opening to an internal door cavity between the inner panel and the outer panel, said carrier comprising:
a carrier body having a wet side and an opposite dry side bounded by an outer periphery configured for attachment to the inner panel to at least partially close off the opening, said carrier body having at least one polymeric insert fixed thereto, said carrier body including:
a textile layer; and
a polymeric material bonded to and cured on at least one of said wet side and said dry side of said textile layer, said at least one insert being fixed to said carrier body via said cured polymeric material.

17. The carrier of claim 16, wherein said textile layer is a natural fibrous non-woven layer.

18. The carrier of claim 17, wherein said nature fibrous non-woven layer is hemp.

19. The carrier of claim 18, wherein said polymeric material is polyurethane.

20. The carrier of claim 19, wherein said polymeric material is coated over the entirety of said wet side and said dry side.
